(19) United States
(12) Patent Application Publication
(10) Pub. No.: US 2016/0290711 A1
(43) Pub. Date: Oct. 6, 2016

(54) CABINET INCLUDING A COMPARTMENT AND METHOD OF MAKING THEREOF

(71) Applicant: Electrolux Home Products, Inc., Charlotte, NC (US)

(72) Inventors: Andrew D. Brown, Anderson, SC (US); Jose Macias, Anderson, SC (US); Marcelo Candeo, Anderson, SC (US); Carlos Cordero, Anderson, SC (US); David Gaussiran, Anderson, SC (US)

(21) Appl. No.: 14/673,982

(22) Filed: Mar. 31, 2015

(51) Int. Cl. F25D 25/02; B29C 51/12

(52) U.S. Cl. CPC F25D 25/02; B29C 51/12; B29K 2101/12

(57) ABSTRACT

A cabinet including a compartment may include a plastic sheet partially defining the compartment and including a formed portion, and a component partially around which the formed portion is set. The component may be embedded within the formed portion.

### FIELD OF INVENTION

The following description relates generally to cabinets including compartments and methods of making cabinets including compartments.

### BACKGROUND OF INVENTION

Cabinet components are often attached to flat cabinet liners after a cabinet foaming process. In this example, cabinet components are fastened by fasteners to anchor nuts attached to the rear of the liner prior to the cabinet foaming process. Thus, precise holes are required for mounting fasteners to the attached anchor nuts.

### SUMMARY

The present invention provides a cabinet including a compartment and a method of making a cabinet including a compartment.

In one general aspect, a cabinet including a compartment, according to the present invention, may include a plastic sheet partially defining the compartment and including a formed portion, and a component partially around which the formed portion is set. The component may be embedded within the formed portion.

The formed portion may be set around a rear profile of the component. The rear profile may be defined by one or more flanges around which the formed portion is set. At least one of the flanges may be contacted on two or more sides by the formed portion. A notched area of the formed portion may be set between at least two of the flanges.

The component may be supported within the formed portion by the plastic sheet. The component may be permanently embedded within the formed portion. A rear wall and foam insulation may be positioned between the rear wall and the plastic sheet.

The component may include one or more flanges around which the formed portion is set and one or more receptacles to which an article is configured to be removably anchored. The receptacles may be open to the compartment. The receptacles may be provided at a portion of the component around which the formed portion is not positioned. The removably anchored article may be supported by the plastic sheet. The article may be defined by a shelf assembly including a shelf surface and one or more shelf anchors fixed to the shelf surface. The shelf anchors may be configured to removably anchor the shelf surface to the component when inserted into the receptacles. The shelf assembly that is anchored to the component by the shelf anchors inserted into the receptacles may be supported by the plastic sheet.

The formed portion may include a notched area set between at least two of the flanges. The formed portion may be set around a rear profile of the component. The rear profile may be defined by the flanges. At least one of the flanges may be contacted on two or more sides by the formed portion. The component may be defined by a rail including the receptacles and the flanges. One or more rows and columns of the receptacles may be positioned on the rail. The shelf assembly may be removably anchored to the rail by an insertion of one of the shelf anchors into one of the receptacles.

The formed portion may be one of a plurality of formed portions that the plastic sheet includes. The rail may be one of a plurality of rails partially around which the formed portions are respectively set. The rails may be respectively embedded within the formed portions. The shelf assembly may be one of a plurality of shelf assemblies being configured to removably anchor corresponding shelf surfaces to at least two of the rails. The shelf anchors may be positioned at opposite sides of the one of the shelf assemblies. The shelf anchors may be configured to removably anchor the shelf surface of the one of the shelf assemblies to at least two of the rails when inserted into the receptacles respectively positioned in the at least two rails.

The cabinet may further include an outer wall and foam insulation positioned between the outer wall and the plastic sheet. The formed portion may protrude from the plastic sheet toward the outer wall. The embedded component may be supported within the formed portion by the plastic sheet and the foam insulation. The embedded component may be supported within the formed portion by the plastic sheet.

In another general aspect, a method of making a cabinet including a compartment may include softening a thermoplastic material and setting the softened thermoplastic material partially around a component to form a plastic sheet defining at least part of the compartment, the formed plastic sheet having a formed portion within which the component is embedded.

The formed portion may be set around a rear profile of the component. The rear profile may be defined by one or more flanges around which the formed portion is set. At least one of the flanges may be contacted on two or more sides by the formed portion. A notched area of the formed portion may be set between at least two of the flanges. The component may be permanently embedded within the formed portion. The component may include one or more flanges around which the formed portion is set and one or more receptacles to which an article is configured to be removably anchored, the receptacles being open to the compartment.

Other features and aspects may be apparent from the following detailed description, the drawings, and the claims.

### BRIEF DESCRIPTION OF THE DRAWINGS

FIG. 1 is a perspective view illustrating an example of a cabinet.

FIG. 2 is a perspective view illustrating an example of a compartment of cabinet.

FIG. 3 is a perspective view illustrating another example of a compartment of the cabinet.

FIG. 4 is a schematic view illustrating an example of a plastic sheet of the compartment including a front side of a component.

FIG. 5 is a schematic view illustrating an example of a rear side of the component.

FIG. 6 is a schematic view illustrating an example of a rear profile of the plastic sheet and foam insulation positioned between an outer wall of the cabinet and the plastic sheet.

FIG. 7 is a cross-sectional perspective view illustrating an example of the plastic sheet including the component across section 7-7 of FIG. 4.

FIG. 8 is a rear perspective view illustrating an example of a shelf being anchored to the component.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Examples incorporating one or more embodiments are described and illustrated in the drawings. These illustrated examples are not intended to be limiting. For example, one or more aspects of an embodiment may be utilized in other embodiments and even other types of devices.

For purposes of the description herein, the setting of softened thermoplastic material may be representative of any number of occurrences, including, but not limited to, forming, cooling, surrounding, fitting, embedding, heating, and solidifying.

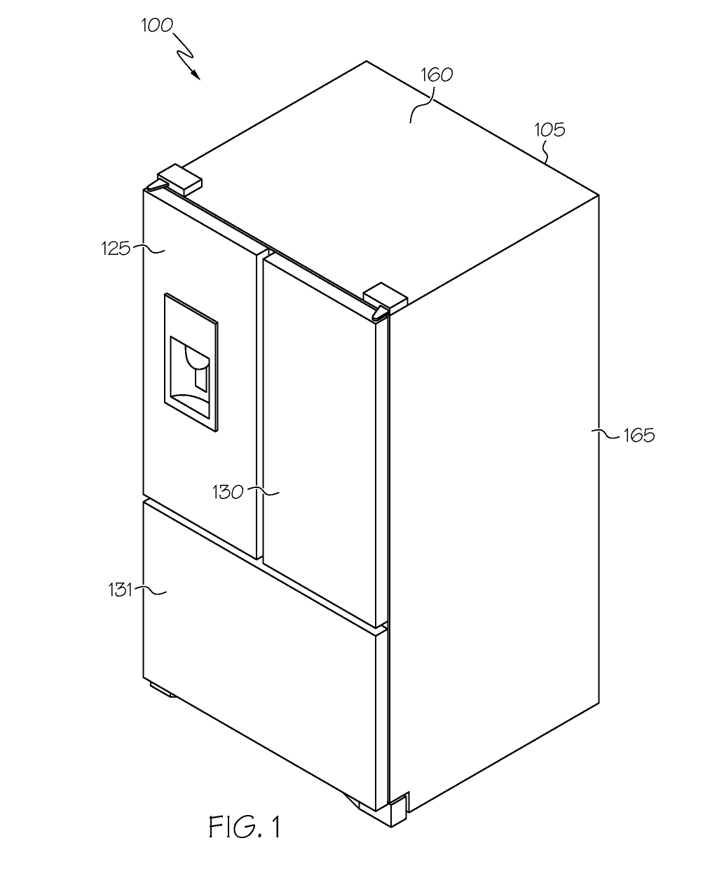

An example cabinet 100 is illustrated in FIG. 1 and may be partially defined by side walls 165, a rear wall 105, and a top wall 160. While the example cabinet 100 is illustrated as a cabinet for a bottom-mount refrigerator, embodiments disclosed herein are not limited thereto. For example, the cabinet 100 described herein may be representative of any type of cabinet, including, but not limited to, those applied in refrigerators, various household appliances, furniture, drawers, and automobiles.

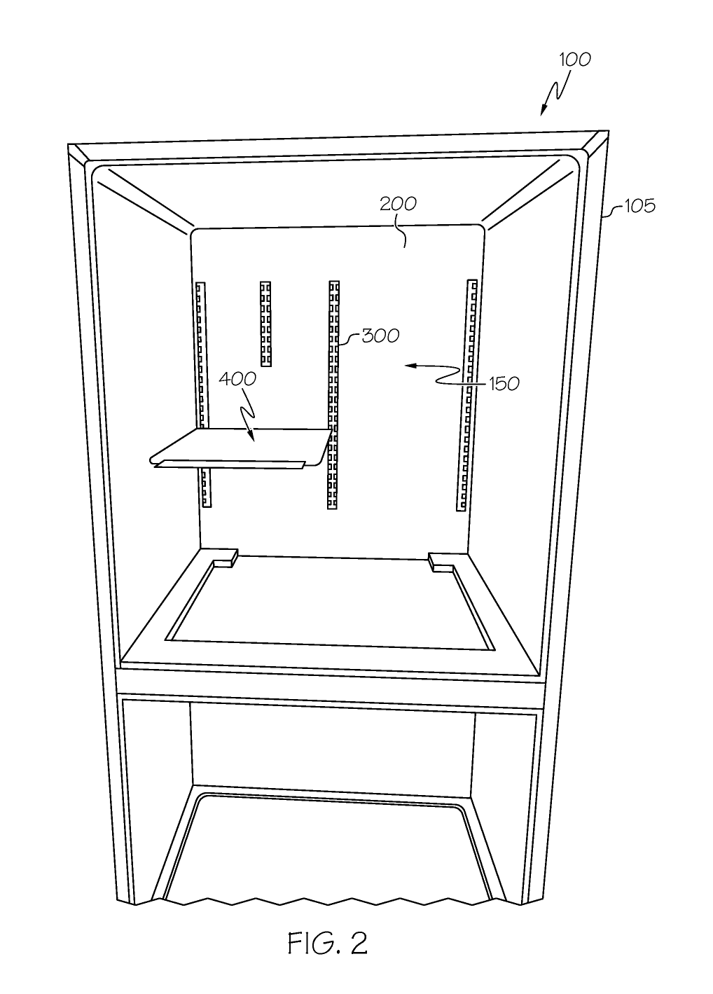

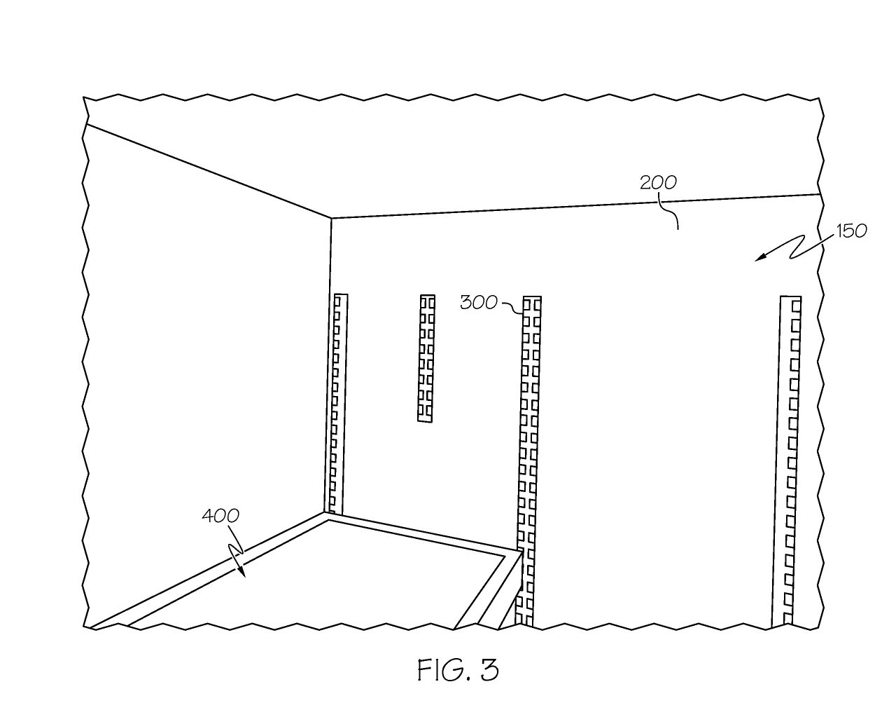

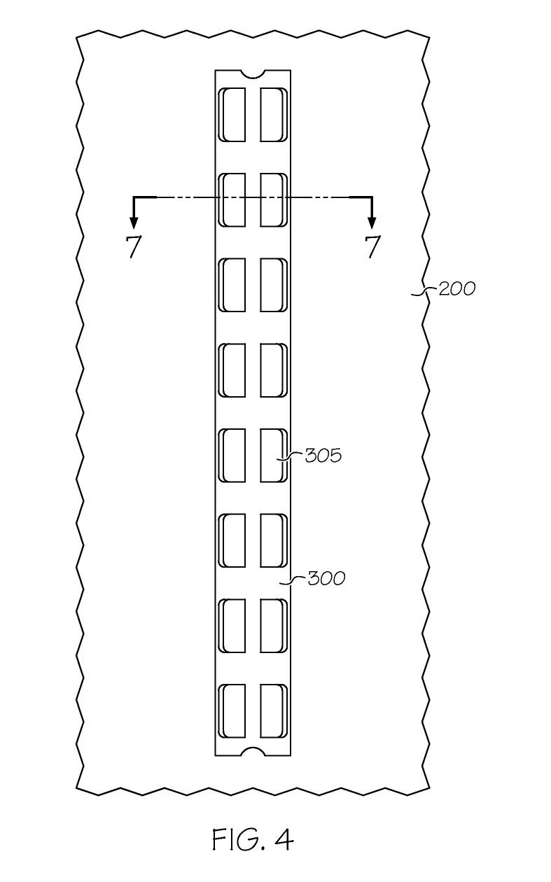

Example doors 125, 130, 131 illustrated in FIG. 1 may be mounted to or within the cabinet 100 to provide access to one or more compartments housed within the cabinet 100. An example compartment 150 positioned within the cabinet 100 is illustrated in FIGS. 2 and 3. The side walls 165, rear wall 105, and top wall 160 of the cabinet 100 may in combination have a shape that partially defines a shape of the compartment 150. At least one example plastic sheet 200 illustrated in FIGS. 2-8 may partially define the compartment 150. The plastic sheet 200 may be formed of a thermoplastic material that has previously been softened by heating or other methods and set prior to being installed to define the shape of the compartment 150.

In examples illustrated herein, the plastic sheet 200 is positioned as a rear wall of the compartment 150 that separates the compartment 150 from the rear wall 105 of the cabinet 100. However, embodiments described herein are not limited thereto. For example, the plastic sheet may be formed in such a way as to define any portion of the compartment 150, including, but not limited to the side walls 165 and the top wall 160 of the compartment 150.

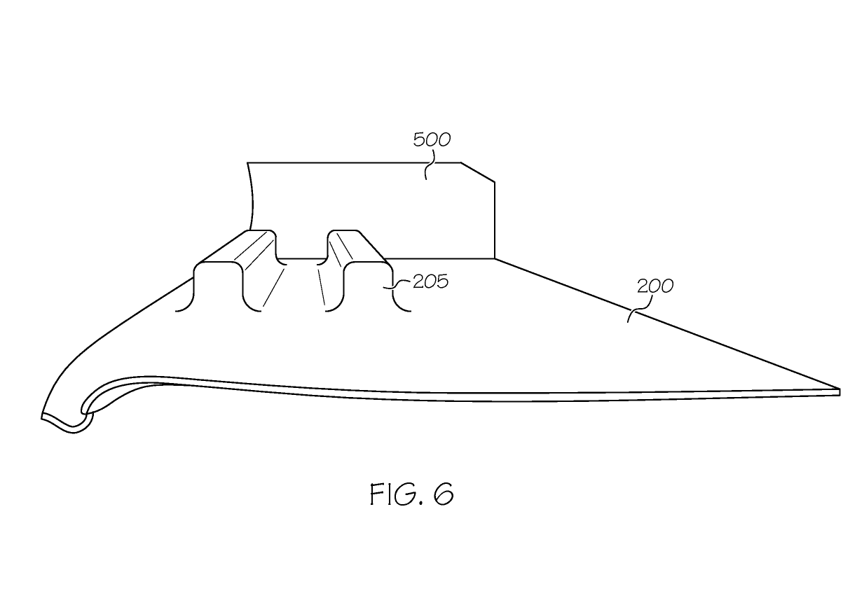

As is illustrated in FIG. 6, foam insulation 500 may be positioned on a rear surface of the example plastic sheet 200. As a result, the foam insulation 500 may extend between the rear surface of the plastic sheet 200 and the rear wall 105 of the cabinet 100. While not illustrated herein, foam insulation 500 may be positioned on all rear surfaces of the plastic sheet 200, which include, but are not limited to, the formed portion 205. Further, the foam insulation 500 may be positioned on all rear surfaces of walls defining the compartment 150, including, but not limited to, the plastic sheet 200, the side walls 160 and the top wall 165 of the compartment 150.

The example cabinet 100 can be provided with more than one compartment 150 as well as any other type of compartment. The plastic sheet 200 described herein may be used to respectively define or partially define any type of compartment, including, but not limited to, compartments implemented in and with respect to refrigerators and various household appliances, furniture, drawers, automobiles, closets, organization, and architecture.

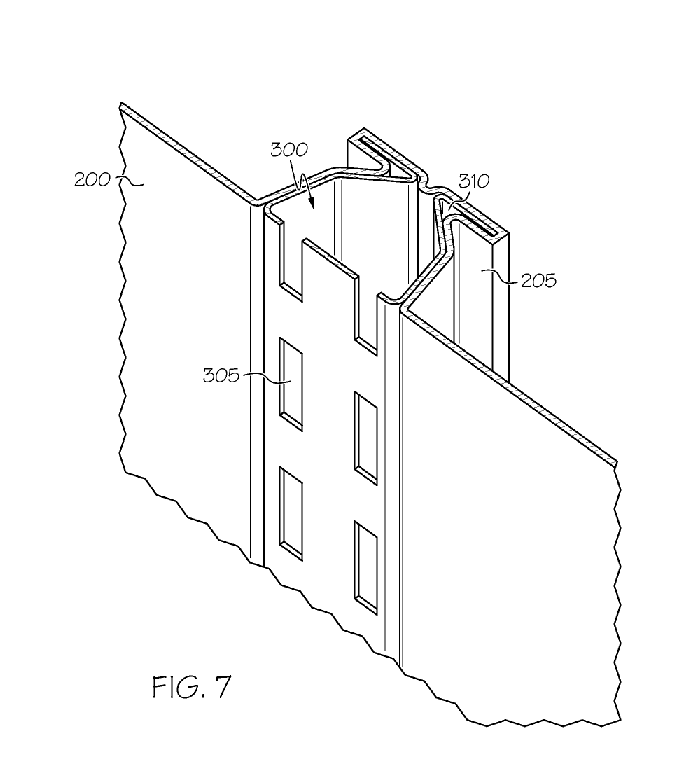

With respect to the form of the example plastic sheet 200 that is applied to partially define the compartment 150 of the cabinet 100, thermoplastic material may be softened by heating or other methods and set partially around an example component 300, which is illustrated in FIGS. 1-5, 7, and 8, to create the plastic sheet 200 having an example formed portion 205 illustrated in FIGS. 6 and 7. The example formed portion 205 of the plastic sheet 200 is created by the setting of softened thermoplastic material around the component 300, thereby serving to embed the component 300 within the formed portion 205. As illustrated in FIGS. 6 and 7, the setting of the softened thermoplastic material around the component 300 may serve to fit the formed portion 205 of the created plastic sheet 200 to the component 300.

As is illustrated in FIGS. 6 and 7, the formed portion 205 may protrude from a rear surface of the plastic sheet 200 in a direction of the rear wall 105 of the cabinet 100. As such, the example foam insulation 500 illustrated in FIG. 6 may extend between the rear surface of the plastic sheet 200 and the rear wall 105 of the cabinet 100. In other words, the foam insulation 500 may extend from the plastic sheet 200 in the same direction as the example formed portion 205 protrudes.

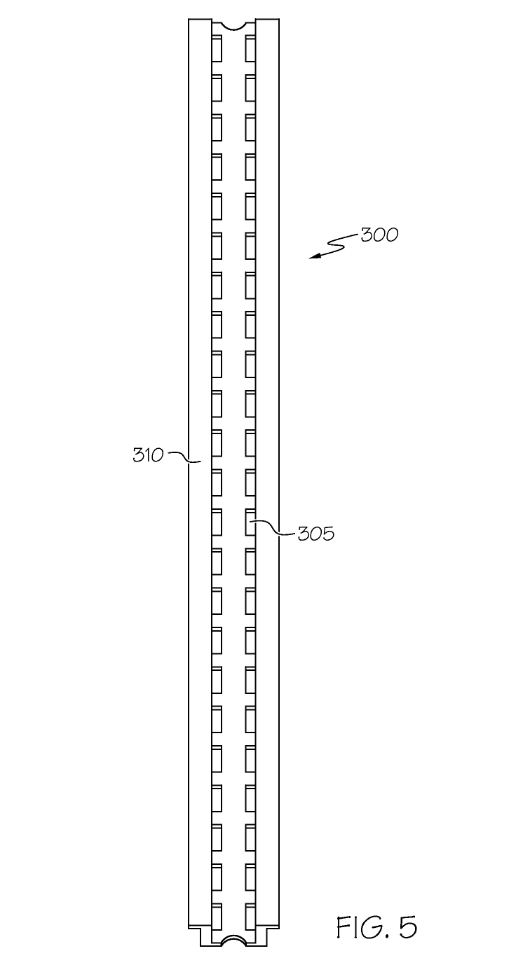

For example, to create the plastic sheet 200 including the formed portion 205 that is set partially around the component 300, thermoplastic material may be softened by heating or other methods in such a way as to surround a rear profile 310 of the component 300 defined by one or more flanges 310, as is illustrated in FIG. 5. The rear profile 310 of the component 300 may have a function similar to that of a die in the forming of a plastic mold from a softened thermoplastic material. For example, a profile of a formed portion 205 may be created through the application of softened thermoplastic material onto the rear profile 310 of the component 300. If the component 300 was being used strictly as a die, a plastic sheet having a newly created formed portion could be removed from the rear profile 310 of the component 300 prior to setting, thereby serving to create a formed portion defining a void cavity located therewithin.

However, contrary to the function of a die, the softened thermoplastic material of the example described herein may be permitted to set around the surfaces of the rear profile 310 of the component 300, thereby serving to embed the component 300 in the same formed portion 205 that the component 300 was utilized to create in such a way that the formed portion 205 is fitted to the rear profile 310 of the component 300. Thus, the complexity of thermoforming operations could be reduced in that the component 300 may be able to define its exact mounting envelope within the plastic sheet 200, as more complex envelope geometry may increase dimensional accuracy in placement of the component 300 during thermoforming.

In addition, the embedding of the component 300 within the formed portion 205 of the plastic sheet 200 may be permanent, as the component 300 might not be removable from the structure of the formed portion 205 after the setting of the softened thermoplastic material. Moreover, the component 300 may be supported by the plastic sheet 200 without the use of fasteners, anchor nuts, punctures or holes within the plastic sheet 200, or piercings of the plastic sheet 200 after the foam insulation 500 is provided between the plastic sheet 200 and the outer wall 105. Further, the component 300 may be supported either solely by the strength of the plastic sheet 200 or by a combination of the strength of the plastic sheet 200 and the force provided by the foam insulation 500. This may result in a reduction of parts needed to construct the cabinet 100, as well as a subsequent reduction of the tooling costs associated with the reduction of parts.

The setting of the thermoplastic material around the flanges 310 of the component 300 may cause the formed portion 205 to contact at least one of the flanges 310 on two or more sides, thereby embedding the aforementioned flange 310 in the formed portion 205. Further, a notched area of the formed portion 205 may set between flanges 310, further serving to embed the flanges 310. Moreover, while not limited hereto, a servo-controlled robot may be utilized to position the component 300 in a location at which the plastic sheet 200 including the formed portion 205 can be created.

In addition, while the rear profile 310 of the component 300 is illustrated as flanges, embodiments described herein are not limited thereto. For example, any sort of flange, projection, lip, overhang, outcropping, protuberance, or extension may be used alone and/or in combination to form a rear profile by which a component can form and be embedded within a formed portion of a plastic sheet.

Further, while a single component 300 is applied to a single formed portion 205 of the plastic sheet 200 in the examples illustrated and described herein, embodiments described herein are not limited thereto. For example, a plurality of the components 300 may be embedded within a respective plurality of the formed portions 205 within the plastic sheet 200.

The example component 300 is more particularly illustrated in FIGS. 3-5, 7, and 8. As is illustrated, at least one portion of the component 300 is positioned and accessible within the compartment 150 of the cabinet 100, thereby having the ability to be accessed and utilized in some way by an article 400. As such, the formed portion 205 of the plastic sheet 200 is not positioned around this portion of the component 300.

The example component 300 illustrated herein may resemble and possess functionality of an example rail statically positioned at a rear wall of the compartment 150, when, in this case, the rear wall of the compartment 150 is represented by the plastic sheet 200. The example rail 300 may be one of a plurality of rails 300 around which a plurality of formed portions 205 is respectively set with the rails 300 being respectively embedded within the formed portions 205.

The rails 300 may include one or more receptacles 305 to which the article 400 is configured to be removably anchored and supported by the plastic sheet 200. The receptacles 305 are open to the compartment 150 and, as such, may be provided at a portion of the component or rail 300 around which the formed portion 205 is not positioned, thereby allowing the receptacles 305 to be accessed for various functional purposes. For example, the article 400 illustrated in FIGS. 1, 2, and 8 may resemble and possess functionality of a cantilever shelf that can be removably anchored to the receptacles 305 and supported by the plastic sheet 200. As such, the article 400 may be anchored to the component 300, and subsequently to the plastic sheet 200 or a combination of the plastic sheet 200 and the foam insulation 500, through use of the receptacles 305 positioned within the component 300. One of more rows and columns of the receptacles 305 may be positioned on the component 300.

While the example component 300 illustrated herein may resemble and possess functionality of a rail positioned at the plastic sheet 200 of the cabinet 100, embodiments described herein are not limited thereto. For example, a component may serve to transport various articles within a cabinet from one location to another. In addition, a component may be a fixture to enable the installation of an additional component within the cabinet. Further, while an example of the article 400 described and illustrated herein resembles and possesses the functionality of a cantilever shelf, embodiments described herein are not limited thereto. For example, an article may be any item known to one having ordinary skill in the art to benefit from being hung within a cabinet, such as, but not limited to, a bin, a tray, a drawer, and rails to slidably support baskets and drawers.

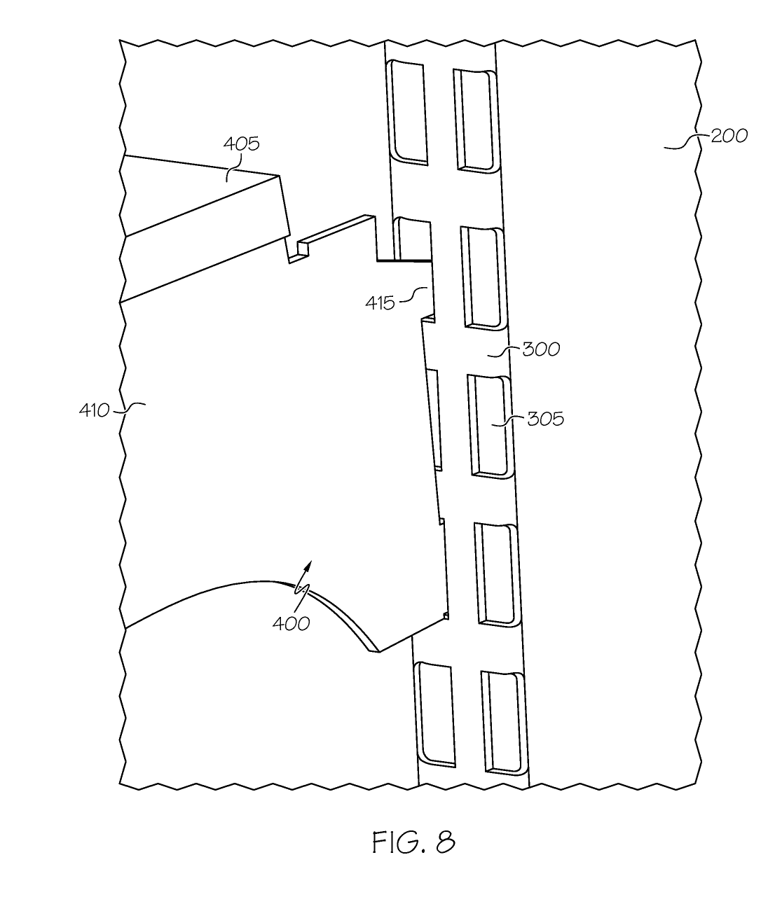

As is illustrated in FIGS. 1, 2, and 8, the example article 400 described and illustrated herein is defined by a shelf assembly. The shelf assembly 400 includes a shelf surface 405 on which food items can be placed and one or more shelf anchors 410 that may be fixed to the shelf surface 405. The shelf anchors 410 may removably anchor the shelf surface 405 to the rail 300 when inserted into the receptacles 305 of the rail 300 such that the shelf assembly 400 is supported by the plastic sheet 200 or a combination of the strength of the plastic sheet 200 and the force provided by the foam insulation 500. As is illustrated in FIG. 8, the shelf anchors 410 integrally includes one or more anchor implements 415 positioned to fit within respectively oriented receptacles 305 of the component 300 to removably secure the shelf assembly 400 as previously mentioned. The anchor implements 415 may be shaped or oriented as hooks, but are not limited thereto.

The shelf assembly 400 may be one of a plurality of shelf assemblies 400 configured to removably anchor corresponding shelf surfaces 405 to at least two of the rails 300. The shelf anchors 410 may be positioned at opposite sides of a shelf assembly 400 and configured to removably anchor one of the shelf assemblies 400 to at least two of the rails 300 when inserted into the receptacles 305 respectively positioned in the two rails 300.

A number of examples have been described above. Nevertheless, it will be understood that various modifications may be made. For example, suitable results may be achieved if the described elements are combined in a different manner and/or replaced or supplemented by other elements or their equivalents. Accordingly, other implementations are within the scope of the following claims.

1. A cabinet including a compartment, the cabinet comprising:
a plastic sheet partially defining the compartment and comprising a formed portion; and
a component partially around which the formed portion is set, the component being embedded within the formed portion, the component including a front plate portion and opposing angled side walls extending from the front plate portion to define an open space between the opposing angled side walls and the front plate portion, a distance between the opposing angled side walls decreasing in a direction away from said front plate portion.

2. (canceled)

3. (canceled)

4. The cabinet of claim 1, wherein at least one of the opposing angled side walls is contacted on two or more sides by the formed portion.

5. (canceled)

6. The cabinet of claim 1, wherein the component is supported within the formed portion by the plastic sheet.

7. The cabinet of claim 1, wherein the component is permanently embedded within the formed portion.

8. The cabinet of claim 1, further comprising a foam insulation positioned on a rear surface of the plastic sheet wherein the formed portion extends into the foam insulation.

9. The cabinet of claim 1, wherein the component further comprises one or more receptacles to which an article is configured to be removably anchored, the receptacles being open to the compartment.

10. The cabinet of claim 9, wherein the one or more receptacles are provided at a portion of the component around which the formed portion is not positioned.

11. The cabinet of claim 9, wherein the removably anchored article is supported by the plastic sheet.

12. The cabinet of claim 9, wherein the article is defined by a shelf assembly comprising a shelf surface and one or more shelf anchors fixed to the shelf surface, the shelf anchors being configured to removably anchor the shelf surface to the component when inserted into the receptacles.

13. The cabinet of claim 12, wherein the shelf assembly that is anchored to the component by the shelf anchors inserted into the receptacles is supported by the plastic sheet.

14. (canceled)

15. The cabinet of claim 13, wherein the component is defined by a rail comprising the receptacles and the opposing angled side walls,
wherein one or more rows and columns of the receptacles are positioned on the rail, and
wherein the shelf assembly is removably anchored to the rail by an insertion of one of the shelf anchors into one of the receptacles.

16. The cabinet of claim 15, wherein the formed portion is one of a plurality of formed portions that the plastic sheet comprises,
wherein the rail is one of a plurality of rails partially around which the formed portions are respectively set, the rails being respectively embedded within the formed portions,
wherein the shelf assembly is one of a plurality of shelf assemblies being configured to removably anchor corresponding shelf surfaces to at least two of the rails, and
wherein the shelf anchors are positioned at opposite sides of the one of the shelf assemblies, the shelf anchors being configured to removably anchor the shelf surface of the one of the shelf assemblies to at least two of the rails when inserted into the receptacles respectively positioned in the at least two rails.

17. A method of making a cabinet including a compartment, comprising:
softening a thermoplastic material; and
setting the softened thermoplastic material partially around a component to form a plastic sheet defining at least part of the compartment, the formed plastic sheet having a formed portion within which the component is embedded, the component including a front plate portion and opposing angled side walls extending from the front plate portion to define an open space between the opposing angled side walls and the front plate portion, a distance between the opposing angled side walls decreasing in a direction away from said front plate portion.

18. (canceled)

19. The method of claim 17, wherein the component is permanently embedded within the formed portion.

20. The method of claim 17, wherein the component comprises one or more receptacles to which an article is configured to be removably anchored, the receptacles being open to the compartment.

21. The cabinet of claim 1, wherein distal ends of the opposing angled side walls define a gap therebetween configured to inhibit the formed portion from extending into the open space between the opposing angled side walls and the front plate portion.

22. The method of claim 17, wherein distal ends of the opposing angled side walls define a gap therebetween configured to inhibit the formed portion from extending into the open space between the opposing angled side walls and the front plate portion.
